(19) United States
(12) Patent Application Publication
(10) Pub. No.: US 2004/0178909 A1
(43) Pub. Date: Sep. 16, 2004

(54) Electronic lock apparatus with automatic locking capability

(76) Inventor: Li-Yun Lu, Taipei City (TW)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/374,051

(22) Filed: Feb. 27, 2003

(51) Int. Cl. E05B 45/06

(52) U.S. Cl. 340/542

(57) ABSTRACT

An electronic lock apparatus includes a deadbolt that is operable for movement between locking and unlocking positions, an actuating unit that is capable of driving movement of the deadbolt to the locking and unlocking positions, a sensor unit that generates a locking control signal, a user input unit that is operable so as to generate an unlocking control signal, and a processing unit that enables the actuating unit to drive movement of the deadbolt to the locking position upon receipt of the locking control signal from the sensor unit, and that enables the actuating unit to drive movement of the deadbolt to the unlocking position in response to the unlocking control signal from the user input unit.

### BACKGROUND OF THE INVENTION

1. Field of the Invention

The invention relates to an electronic lock apparatus, more particularly to an electronic lock apparatus with an automatic locking capability.

2. Description of the Related Art

A conventional lock apparatus for locking and unlocking a door panel on a door frame includes a deadbolt. The deadbolt is adapted to be mounted on the door panel and is operable for movement between a locking position, where the deadbolt is extended relative to the door panel so as to be adapted to engage the door frame, and an unlocking position, where the deadbolt is retracted relative to the door panel so as to be adapted to disengage from the door frame. The deadbolt of the conventional lock apparatus is moved to the unlocking position with the use of a key or by asking someone to operate the deadbolt from the inside of a room to the unlocking position. These cause inconveniences on the part of the user.

### SUMMARY OF THE INVENTION

Therefore, the object of the present invention is to provide an electronic lock apparatus that includes a deadbolt that can be moved to locking and unlocking positions without the use of a key so as to overcome the aforesaid drawbacks of the prior art.

According to the present invention, an electronic lock apparatus comprises a deadbolt, an actuating unit, a sensor unit, a processing unit, and a user input. The deadbolt is adapted to be mounted on a door panel and is operable for movement between a locking position, where the deadbolt is extended relative to the door panel so as to be adapted to engage a door frame, and an unlocking position, where the deadbolt is retracted relative to the door panel so as to be adapted to disengage from the door frame. The actuating unit is adapted to be mounted on the door panel, is coupled to the deadbolt, and is capable of driving movement of the deadbolt to the locking and unlocking positions. The sensor unit is adapted to generate a locking control signal upon detection that the door panel is at a closed position relative to the door frame. The processing unit is coupled electrically to the sensor unit and the actuating unit. The processing unit receives the locking control signal from the sensor unit, and enables the actuating unit to drive movement of the deadbolt to the locking position upon receipt of the locking control signal from the sensor unit. The user input unit is coupled electrically to the processing unit and is operable so as to generate an unlocking control signal that is provided to the processing unit. The processing unit enables the actuating unit to drive movement of the deadbolt to the unlocking position in response to the unlocking control signal from the user input unit.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of the preferred embodiment of an electronic lock apparatus according to the present invention;

FIG. 2 is a schematic view of the preferred embodiment, illustrating a deadbolt in a locking position;

FIG. 3 is a schematic view of the preferred embodiment, illustrating the deadbolt in an unlocking position; and

FIG. 4 is a schematic circuit diagram of the preferred embodiment.

### DETAILED DESCRIPTION OF THE PREFERRED EMBODIMENT

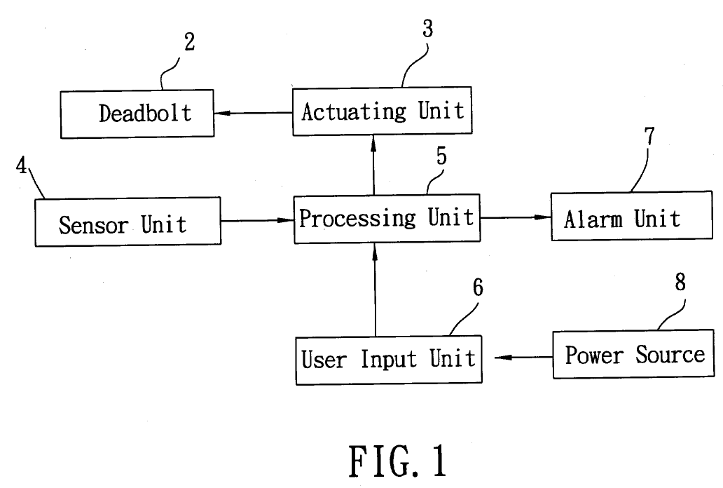

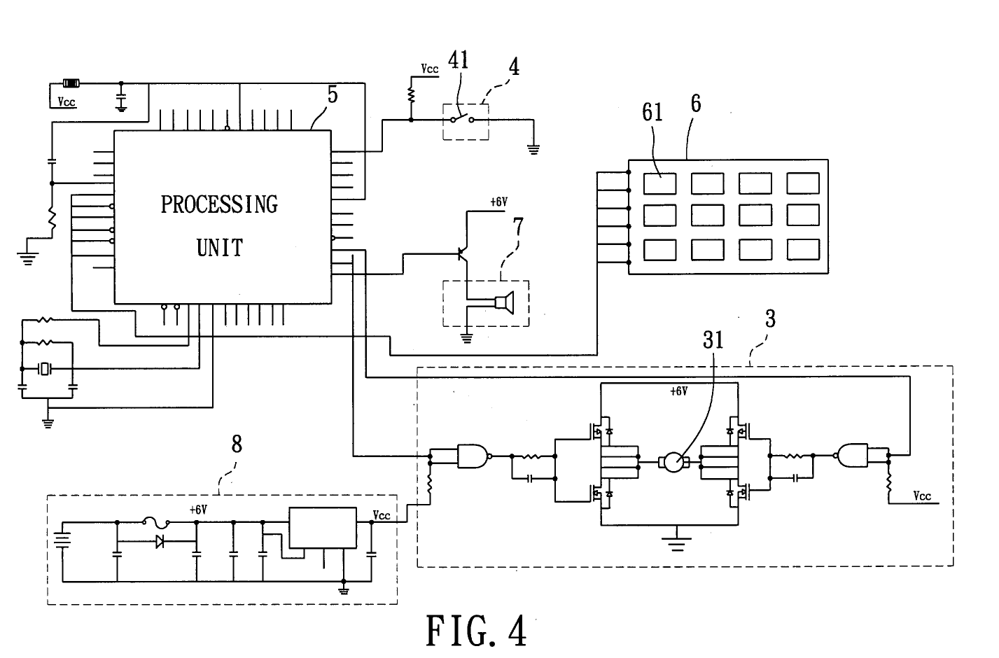

Referring to FIGS. 1 to 4, the preferred embodiment of an electronic lock apparatus f or locking and unlocking a door panel 11 on a door frame 12 according to the present invention is shown to include a deadbolt 2, an actuating unit 3, a sensor unit 4, a processing unit 5, and a user input unit 6.

The door frame 12 includes vertical left and right frame members 122, 121. The door panel 11 has a right end portion 111 hinged to the door frame 12 in a conventional manner so as to permit the door panel 11 to be pivoted relative to the right frame member 121 for opening and closing the door panel 11.

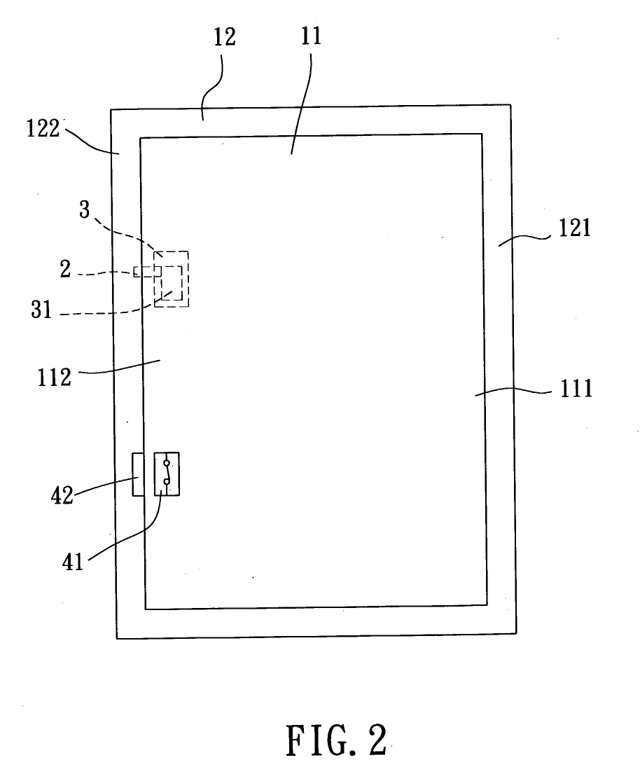

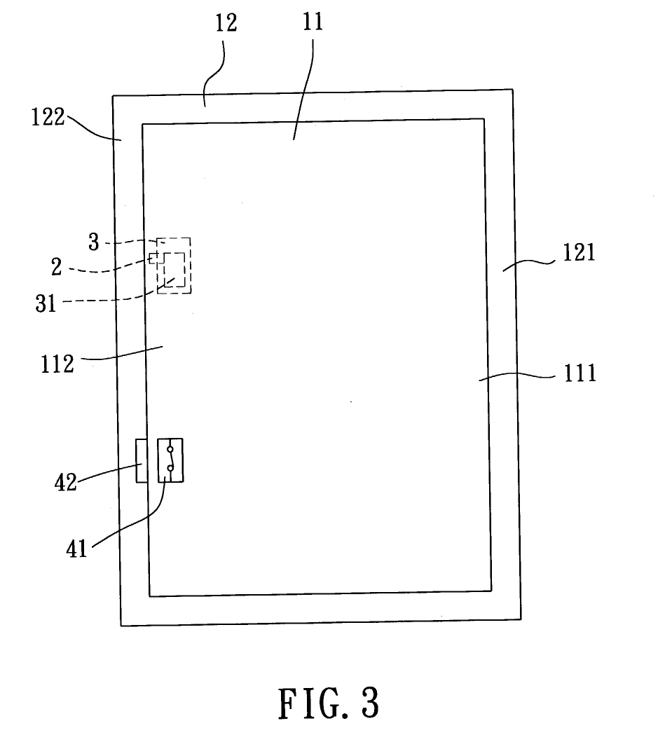

The deadbolt 2 is adapted to be mounted horizontally on a left end portion 112 of the door panel 11 and is operable for movement between a locking position shown in FIG. 2, where the deadbolt 2 is extended relative to the door panel 11 so as to be adapted to engage the door frame 12, and an unlocking position shown in FIG. 3, where the deadbolt 2 is retracted relative to the door panel 11 so as to be adapted to disengage from the door frame 12.

The actuating unit 3 is adapted to be mounted on the door panel 11, is coupled to the deadbolt 2, and is capable of driving movement of the deadbolt 2 to the locking and unlocking positions. In this embodiment, the actuating unit 3 includes a bi-directional motor 31 that is rotatable in a first direction so as to move the deadbolt 2 to the locking position, and in a second direction opposite to the first direction so as to move the deadbolt 2 to the unlocking positions. Since the construction of the bi-directional motor 31 is known to those skilled in the art, a detailed description of the same will be dispensed with herein for the sake of brevity.

The sensor unit 4 is adapted to generate a locking control signal upon detection that the door panel 11 is at a closed position relative to the door frame 12. In this embodiment, the sensor unit 4 includes a magnetic reed switch 41. The magnetic reed switch 41 is mounted on the left end portion 112 of the door panel 11. A magnet 42 is mounted on the left frame member 122 of the door frame 12 such that the magnet 42 is in close proximity with the magnetic reed switch 41 when the door panel 11 is at the closed position relative to the door frame 12. As such, the magnetic reed switch 41 detects magnetic flux of the magnet 42 and generates the locking control signal in accordance with the closed state of the door panel 11. In other embodiments, the sensor unit 4 may be implemented as an optical sensor, a proximity sensor, etc.

In this embodiment, the processing unit 5 is mounted on the door panel 11, is coupled electrically to the sensor unit 4 and the actuating unit 3, receives the locking control signal from the sensor unit 4, and enables the actuating unit 3 to drive movement of the deadbolt 2 to the locking position upon receipt of the locking control signal from the sensor unit 4. Alternatively, the processing unit 5 may be mounted on the door frame 12 or on any other appropriate location.

The user input unit 6 is mounted on the door panel 11 such that the user input unit 6 is accessible from the outer side of the door panel 11, is coupled electrically to the processing unit 5, and is operable so as to generate an unlocking control signal that is provided to the processing unit 5 and so as to provide configuration codes for configuring the processing unit 5. The processing unit 5 enables the actuating unit 3 to drive movement of the deadbolt 2 to the unlocking position in response to the unlocking control signal from the user input unit 6, and is configured so as to enable the actuating unit 3 to drive movement of the deadbolt 2 to the locking position after a predetermined delay period has elapsed since receipt of the locking control signal from the sensor unit 4. The delay period can be set to a desired period, such as 0 second, 1 second, 2 seconds, etc. In this embodiment, the user input unit 6 includes a keypad 61. As such, codes can be inputed through the user input unit 6 so as to generate and provide the unlocking control signal and the configuration codes to the processing unit 5. In other embodiments, the user input unit 6 can be in the form of a magnetic card reader, a wireless receiver, etc. As such, the codes can be transmitted wirelessly to the user input unit 6.

The electronic lock apparatus further comprises an alarm unit 7, an unlocking unit (not shown), and a power supplying unit (not shown). The alarm unit 7 is coupled electrically to the processing unit 5 and produces an alarm output when activated. The processing unit 5 activates the alarm unit 7 when the sensor unit 4 detects opening movement of the door panel 11 without the processing unit 5 first receiving the unlocking control signal from the user input unit 6. The alarm output can be in the form of a siren or a light output. The unlocking unit is accessible from the inner side of the door panel 11 and is operable so as to generate an unlocking control signal that is provided to the processing unit 5. The power supplying unit interconnects the actuating unit 3, the sensor unit 4, the processing unit 5, the alarm unit 7, the user input unit 6, and the unlocking unit to a power source 8.

It has thus been shown that the electronic lock apparatus of the present invention includes a deadbolt 2, an actuating unit 3 that is capable of driving movement of the deadbolt 2 to the locking and unlocking positions, a sensor unit 4 that generates a locking control signal, a user input unit 6 that is operable so as to generate an unlocking control signal, and a processing unit 5 that receives the locking and unlocking control signals. The arrangement as such allows the processing unit 5 to enable the actuating unit 3 to drive movement of the deadbolt 2 to the locking and locking positions. Accordingly, the aforesaid drawbacks of the prior art can be overcome.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electronic lock apparatus for locking and unlocking a door panel on a door frame, said electronic lock apparatus comprising:
a deadbolt adapted to be mounted on the door panel and operable for movement between a locking position, where said deadbolt is extended relative to the door panel so as to be adapted to engage the door frame, and an unlocking position, where said deadbolt is retracted relative to the door panel so as to be adapted to disengage from the door frame;
an actuating unit adapted to be mounted on the door panel, coupled to said deadbolt, and capable of driving movement of said deadbolt to the locking and unlocking positions;
a sensor unit adapted to generate a locking control signal upon detection that the door panel is at a closed position relative to the door frame;
a processing unit coupled electrically to said sensor unit and said actuating unit, said processing unit receiving the locking control signal from said sensor unit, and enabling said actuating unit to drive movement of said deadbolt to the locking position upon receipt of the locking control signal from said sensor unit; and
a user input unit coupled electrically to said processing unit and operable so as to generate an unlocking control signal that is provided to said processing unit, wherein said processing unit enables said actuating unit to drive movement of said deadbolt to the unlocking position in response to the unlocking control signal from said user input unit.

2. The electronic lock apparatus as claimed in claim 1, further comprising an alarm unit that is coupled electrically to said processing unit and that produces an alarm output when activated, said processing unit activating said alarm unit when said sensor unit detects opening movement of the door panel without first receiving the unlocking control signal from said user input unit.

3. The electronic lock apparatus as claimed in claim 1, wherein said user input unit is operable so as to provide configuration codes for configuring said processing unit.

4. The electronic lock apparatus as claimed in claim 1, wherein said processing unit is configured so as to enable said actuating unit to drive movement of said deadbolt to the locking position after a predetermined delay period has elapsed since receipt of the locking control signal from said sensor unit.

5. The electronic lock apparatus as claimed in claim 1, wherein said actuating unit includes a bi-directional motor.

6. The electronic lock apparatus as claimed in claim 1, wherein said sensor unit includes a magnetic reed switch.

7. The electronic lock apparatus as claimed in claim 1, wherein said user input unit includes a keypad.
